(19) United States
(12) Patent Application Publication
(10) Pub. No.: US 2008/0147829 A1
(43) Pub. Date: Jun. 19, 2008

(54) DEVICE AND METHOD FOR PARAMETER ADJUSTMENT

(75) Inventor: KUNG-TAI CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/956,343

(22) Filed: Dec. 14, 2007

(30) Foreign Application Priority Data
Dec. 15, 2006 (CN) 200610157538.9

(51) Int. Cl. G06F 11/30; G06F 15/177

(52) U.S. Cl. 709/221

(57) ABSTRACT

A parameter adjustment device (100) for a network device testing system (10) having a head-end device (102) and a central office device (104) includes a data collection module (1001), a data parsing module (1003), and a data management module (1009). The data collection module is used for collecting connection data on the head-end device and parameters on the central office device. The data parsing module is used for parsing the connection data on the head-end device and the parameters on the central office device to determine whether the head-end device has new connection data indicating a new established connection associated with the head-end device. The data management module is used for adding a set of new parameters associated with the new connection data to the central office device data if the head-end device has the new connection data.

### BACKGROUND

1. Field of the Invention

The invention relates to device testing, and particularly to a parameter adjustment device employed in communication device tests.

2. Description of related art

In a mode manufacturing plant, all modems produced must undergo various test procedures for quality assurance before leaving the modem manufacturing plant. A typical test system for modem testing is composed of head-end devices and central office devices such as a digital subscriber line access multiplexer (DSLAM), a switch, and a router. The router must provide a bridge function, a route function, a point to point over asynchronous transfer mode (PPPOA) function, and a point to point over Ethernet (PPPOE) function to simulate various test environments.

A modem testing system generally includes a plurality of testing circuits, which may usually be selectively used under different testing environments. The selected testing circuits used require different parameters for testing different functions. At present, traditional technology loads all parameters of testing circuits into a router. However, this causes the router to run slowly and lowers testing efficiency.

### SUMMARY

One embodiment of the invention provides a parameter adjustment device. The parameter adjustment device for a network device testing system having a head-end device and a central office device includes a data collection module, a data parsing module, and a data management module. The data collection module is used for collecting connection data on the head-end device and parameters on the central office device. The data parsing module is used for parsing the connection data on the head-end device and the parameters on the central office device to determine whether the head-end device has new connection data indicating a new established connection associated with the head-end device. The data management module is used for adding a set of new parameters associated with the new connection data to the central office device data if the head-end device has the new connection data.

Other advantages and novel features will become more apparent from the following detailed description when taken in conjunction with the accompanying drawings, in which:

### BRIEF DESCRIPTION OF THE DRAWINGS

FIG. 1 is a block diagram of an application environment of a parameter adjustment device in accordance with an exemplary embodiment of the invention;

FIG. 2 shows a block diagram of an exemplary embodiment of the parameter adjustment device; and

FIG. 3 shows a flow chart of a method for parameter adjustment in accordance with a further exemplary embodiment of the invention.

### DETAILED DESCRIPTION OF THE EMBODIMENTS

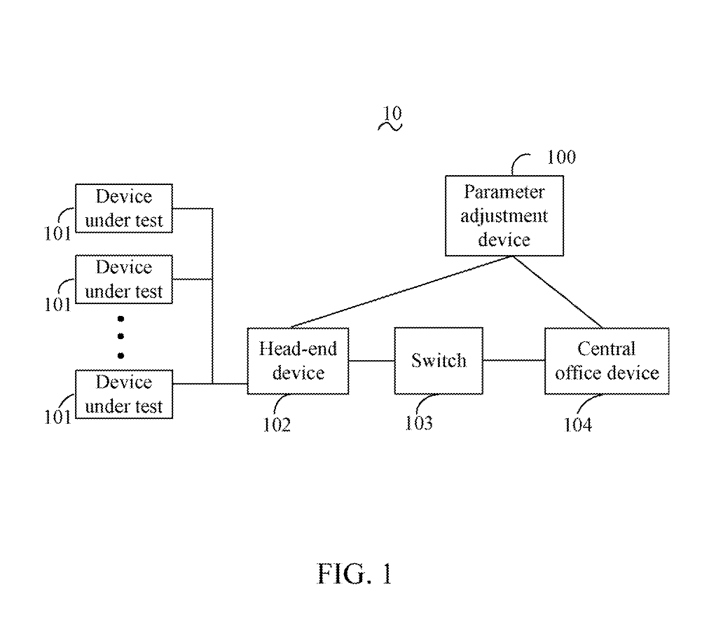

FIG. 1 is a block diagram of an application environment of a parameter adjustment device 100 in accordance with an exemplary embodiment of the invention. In the exemplary embodiment, many devices under test (DUTs) 101 are connected to a head-end device 102 in a network device testing system 10. The DUTs 101 may be dynamically connected or disconnected to/from the head-end device 102. In the exemplary embodiment, the head-end device 102 is not limited to a digital subscriber line access multiplexer (DSLAM). In other exemplary embodiments, the head-end device 102 may be a gateway device, such as a Voice Over Internet Protocol (VoIP) gateway or any other applicable device. The head-end device 102 is connected to a central office device 104 via a switch 103. In the exemplary embodiment, the central office device 104 may be a router. In other exemplary embodiments, the central office device 104 may be any other applicable device. The parameter adjustment device 100 is connected to the head-end device 102 as well as the central office device 104. In the exemplary embodiment, the DUT 101 may be a modem, such as an asymmetric digital subscriber line (ADSL) modem.

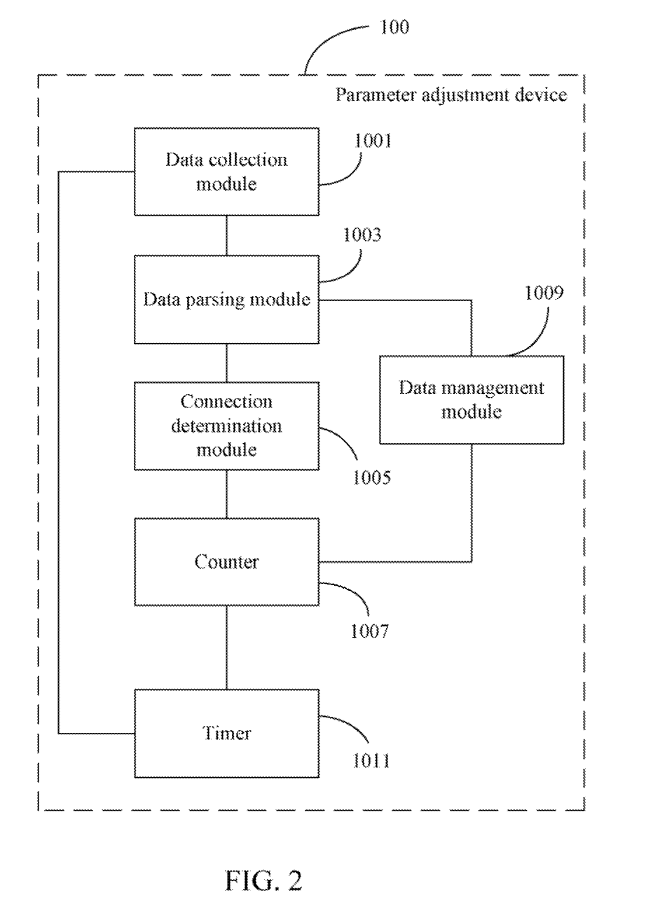

FIG. 2 shows a block diagram of an exemplary embodiment of the parameter adjustment device 100. In the exemplary embodiment, the parameter adjustment device 100 includes a data collection module 1001, a data parsing module 1003, a connection determination module 1005, a counter 1007, a data management module 1009, and a timer 1011.

In the exemplary embodiment, the data collection module 1001 is used for collecting connection data on the head-end device 102 and parameters on the central office device 104. The connection data include connection identifiers retrievable from the head-end device 102, which may indicate all active connections associated with the head-end device 102, such as connections between the DUTs 101 and the head-end device 102. The parameters on the central office device 104 may comprise connection identifiers assigned or to be assigned to connections from the head-end device 102 through the switch 103 to the central office device 104. The connection identifier of the central office device 104 may comprise virtual channel identifiers (VCI) and virtual path identifiers (VPI) utilizable for the asynchronous transfer mode (ATM) layer. In the exemplary embodiment, the connection data and the parameters may both include a connection card number and a connection port number, such as a card number and a port number of a DSLAM. The card number and the connection port number may be stored in a permanent virtual circuit (PVC) packet.

The data parsing module 1003 is used for parsing the connection data on the head-end device 102 and the parameters on the central office device 104, and determining whether the head-end device 102 has new connection data indicating a new connection established between a DUT 101 and the head-end device 102. In the exemplary embodiment, the data parsing module 1003 may determine whether the head-end device 102 has the new connection data by comparing all connection identifiers of the head-end device 102 with all connection identifiers of the central office device 104. If there is one connection identifier of the head-end device 102 that cannot be found in the connection identifiers of the central office device 104, the data parsing module 1003 determines that the head-end device 102 has new connection data. If all connection identifiers of the head-end device 102 match with the connection identifiers of the central office device 104, the head-end device 102 does not have new connection data.

The connection determination module 1005 is used for determining whether one or more ports on the head-end device are kept open, i.e. whether one or more of the ports remains connected to one or more DUTs 101. In the exemplary embodiment, the connection determination module 1005 may determine whether a connected port of the head-end device 102 is kept open by determining whether a current port number of the port matches a connection port number associated with a set of parameters used in the central office device 104.

For each port of the head-end device 102, the counter 1007 is used for recording a time value during which the port of head-end device 102 is closed, i.e. an indicating value showing how long the port of the head-end device 102 has been disconnected from the device 101 since previously connected to the port. The counter 1007 may compare a recorded time period of a port with a preset time value.

The data management module 1009 is used for managing the parameters on the central office device 104. In the exemplary embodiment, the data management module 1009 removes parameters from or adds parameters to the central office device 104. The data management module 1009 adds the new connection identifiers each including a VPI and a VCI to the central office device 104 as new parameter data if the data parsing module 1 003 determines that the head-end device 102 has the new connection data. The data management module 1009 deletes sets of parameters corresponding to the disconnected ports of the head-end device 102 if the period of time of the port recorded by the counter 1007 is more than the preset value.

The timer 1011 is used for tracking a preset time interval, and periodically initiates the data collection module 1001 to collect the connection data on the head-end device 102 and the parameters on the central office device 104 according to the time interval. The central office device 104 initiates one or more functions for new connections to the head-end device 102 according to the new parameters added to the central office device 104. The one or more functions may comprise a bridge function, a route function, a point to point over asynchronous transfer mode function (PPPOA), and a point to point over Ethernet (PPPOE) function.

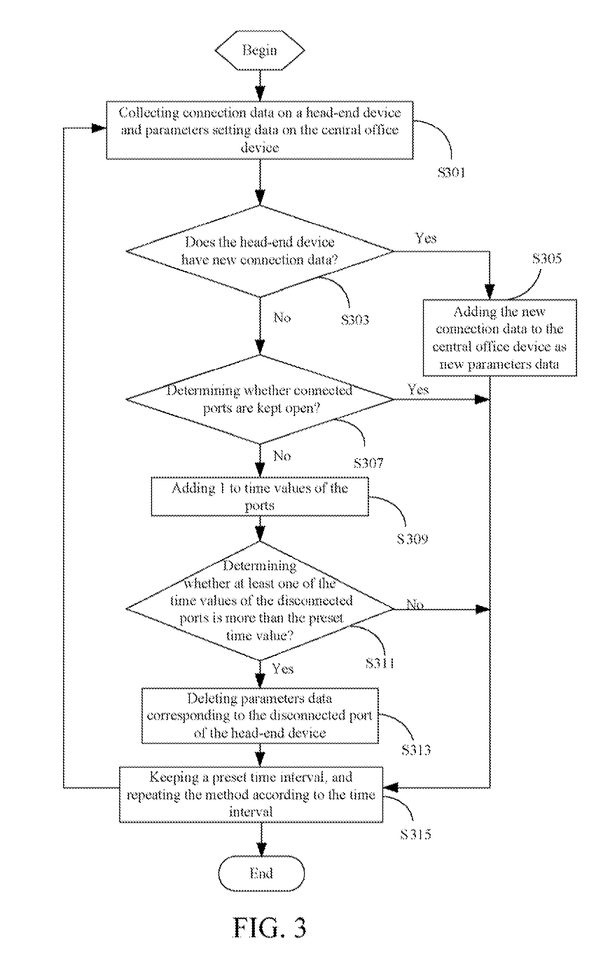

FIG. 3 shows a flow chart of a method for parameter adjustment in accordance with a further exemplary embodiment of the invention. In step S301, the data collection module 1001 collects the connection data on the head-end device 102 and the parameters on the central office device 104. The connection data include connection identifiers retrievable from the head-end device 102 may indicate all active connections associated with the head-end device 102, such as connections between the DUTs 101 and the head-end device 102. The parameters on the central office device 104 may comprise connection identifiers assigned or to be assigned to connections from the head-end device 102 through the switch 103 to the central office device 104. The connection identifier of the central office device 104 may comprise virtual channel identifiers (VCI) and virtual path identifiers (VPI) utilizable for the asynchronous transfer mode (ATM) layer. In the exemplary embodiment, the connection data and the parameters may both include a connection card number and a connection port number, such as a card number and a port number of a DSLAM. The card number and the connection port number may be stored in a permanent virtual circuit (PVC) packet.

In step S303, the data parsing module 1003 parses the connection data on the head-end device 102 and the parameters on the central office device 104, and determines whether the head-end device 102 has new connection data indicating a new connection established between a DUT 101 and the head-end device 102. If so, execution of the method goes to step S305, otherwise it goes to step S307.

In step S305, the data management module 1009 adds the new connection identifiers each including a VPI and a VCI to the central office device 104 as new parameters data.

In step S307, the connection determination module 1005 determines whether the connected port is kept open. If so, execution of the method is goes to step S315, otherwise it goes to step S309.

In step S309, the counter 1007 adds 1 to the time values of the disconnected ports.

In step S311, the counter 1007 determines whether at least one of the time values of the disconnected ports is more than the preset value. If so, turn to step S313, otherwise turn to step S315.

In step S313, the data management module 1009 deletes sets of parameters corresponding to the disconnected port of the head-end device 102.

In step S315, the timer 1011 keeps a preset time interval, and periodically initiates the data collection module 1001 for collecting the connection data on the head-end device 102 and the parameters on the central office device 104 according to the time interval. For example, the method is restarted at the end of the interval.

The parameter adjustment device 100 and the method for parameter adjustment make the data parsing module 1003 parse the connection data on the head-end device 102 and the parameters on the central office device 104, and automatically adjust the parameter setting of the central office device 104 according to a parsing result of the data parsing module 1003, thus improving testing efficiency and memory efficiency of the central office device 104.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A parameter adjustment device for a network device testing system having a head-end device and a central office device comprising:
a data collection module for collecting connection data on the head-end device and parameters on the central office device;
a data parsing module for parsing the connection data on the head-end device and the parameters on the central office device to determine whether the head-end device has new connection data indicating a new established connection associated with the head-end device; and
a data management module for adding a set of new parameters associated with the new connection data to the central office device data if the head-end device has the new connection data.

2. The parameter adjustment device of claim 1, wherein the connection data comprises a connection card number and a connection port number associating the head-end device with a device under test.

3. The parameter adjustment device of claim 1, further comprising:
a connection determination module for determining if a first port on the head-end device remains in connection to a device under test; and
a counter for recording a time value showing how long the first port has been disconnected from the device under test.

4. The parameter adjustment device of claim 3, wherein the data management module is further used for deleting a set of the parameters corresponding to the first port from the central office device if the time value is more than a preset time value.

5. The parameter adjustment device of claim 3, further comprising a timer for keeping a preset time period for periodically initiating the data collection module for collecting the connection data on the head-end device and the parameters on the central office device.

6. The parameter adjustment device of claim 1, wherein the head-end device comprises a digital subscriber line access multiplexer (DSLAM), and the central office device comprises a router.

7. The parameter adjustment device of claim 1, wherein the central office device initiates one or more functions for the new connection according to the set of the new parameters.

8. The parameter adjustment device of claim 1, wherein the one or more functions comprise a bridge function, a route function, a point to point over asynchronous transfer mode function (PPPOA), and a point to point over Ethernet (PPPOE) function.

9. A method for parameter adjustment, used in a network device testing system provided a head-end device, a central office device, and a plurality of devices under test (DUTs), comprising:
collecting connection data on the head-end device and parameters on the central office device;
parsing the connection data on the head-end device and the parameters on the central office device, and determining whether the head-end device has new connection data indicating a new established connection associated with the head-end device; and
adding a set of new parameters associated with the new connection data to the central office device data if the head-end device has the new connection data.

10. The method of claim 9, wherein the connection data comprises a connection card number and a connection port number associating the head-end device with a DUT.

11. The method of claim 10, further comprising:
tracking a preset time interval; and
collecting the connection data on the head-end device and the parameters on the central office device according to the time interval.

12. The method of claim 11, further comprising:
determining whether a first port on the head-end device remains in connection to a DUT;
recording and comparing a time value showing how long the first port has been disconnected from the DUT; and
deleting a set of the parameters corresponding to the first port from the central office device if the time value is more than a preset value.

13. A method for parameter adjustment in a system for testing network devices, comprising:
collecting connection data of said system indicating connections between said system and network devices under test;
collecting testing parameters set in a central office device of said system for corresponding ones of said connections;
parsing said collected connection data and said collected parameters to determine whether said connections between said system and said network devices under test correspond to all of said collected parameters set in said central office device; and
adjusting said parameters set in said central office device to correspond to said parsed connection data.

14. The method of claim 13, wherein said parameters set in said central office device is adjusted by adding a set of new parameters corresponding to a new connection between said system and said network devices under test according to said parsed connection data and said parsed parameters.

15. The method of claim 13, wherein said parameters set in said central office device is adjusted by deleting a set of parameters from said central office device when a connection corresponding to said set of parameters is disconnected for a time valued more than a preset value.
